(19) United States
(12) Patent Application Publication
(10) Pub. No.: US 2022/0398544 A1
(43) Pub. Date: Dec. 15, 2022

(54) TRACKING INTENDED AND ACTUAL PARTICIPATION IN A MEETING

(71) Applicant: MICROSOFT TECHNOLOGY LICENSING, LLC, Redmond, WA (US)

(72) Inventors: Charlie CHUNG, Redmond, WA (US); Selvaraj NALLIAH, Kirkland, WA (US); Victoria Carolina RODRIGUEZ, Seattle, WA (US); Abhishek Kumar CHATURVEDI, Redmond, WA (US); Ricardo Alberto ROSALES GUERRERO, Seattle, WA (US)

(21) Appl. No.: 17/777,224

(22) PCT Filed: Nov. 13, 2020
(86) PCT No.: PCT/US2020/060411

§ 371 Date: May 16, 2022

(30) Foreign Application Priority Data
Nov. 14, 2019 (NL) 2024232

(51) Int. Cl. G06Q 10/10; G06Q 10/02

(52) U.S. Cl. CPC G06Q 10/1095; G06Q 10/02

(57) ABSTRACT

This disclosure concerns systems and methods for tracking participation in meetings and managing conference rooms. A participation object may be used. The participation object may include an intended participation status and real-time participation status for each invitee to a meeting. The intended participation statuses may indicate whether each invitee intends to participate in the meeting and how each invitee intends to participate in the meeting. The intended participation statuses may be updated based on responses to meeting invitations. The real-time participation statuses may indicate whether each invitee is currently participating in the meeting and how each invitee is currently participating in the meeting. The real-time participation statuses may be updated based on check-ins. The check-ins may be received close to a start time of the meeting and during the meeting. The participation object may also include a meeting summary. The meeting summary may summarize participation in the meeting.

### BACKGROUND

An enterprise may have assets and resources that are used as part of the business activities of the enterprise. The employees of the enterprise may use the assets and resources of the enterprise to perform the business of the enterprise. The enterprise may also make the assets and resources available for customers to use as part of the enterprise's business. As part of an effort to promote orderly use of the assets and resources, the enterprise may allow individuals and entities to reserve use of the assets and resources. For example, the enterprise may have a plurality of conference rooms that it makes available for employees and others to use. Employees may be permitted to reserve a conference room for use using a reservation system. The enterprise may have policies governing the use of its resources.

Employees of the enterprise may use one or more computing devices in connection with performing work for the enterprise. The one or more computing devices may provide the employees access to digital communication systems, such as electronic messaging systems (e.g., email, texting, instant messaging systems) and collaboration systems. The one or more computing devices may also give the employees access to an electronic calendar system. The electronic calendar system may allow the employees to schedule meetings and receive invitations to meetings. The meetings may be scheduled to take place in a particular location, such as a specified conference room.

### SUMMARY

In accordance with the present disclosure, a method is disclosed for tracking participation in a meeting. The method includes receiving a first check-in for a first invitee regarding a first presence of the first invitee at the meeting and updating a first real-time status for the first invitee based on the first check-in. The first invitee is among a plurality of invitees. Each of the plurality of invitees has an associated real-time status that indicates a current status of each of the plurality of invitees with respect to participating in the meeting.

The method may further include sending, before a start time of the meeting, a meeting invitation to the plurality of invitees. Each of the plurality of invitees may have an associated intended participation status. The intended participation status for each of the plurality of invitees may indicate whether each invitee intends to attend the meeting and, if applicable, how each invitee intends to attend the meeting. The intended participation status for each invitee may be separate from the real-time status for each invitee. The method may further include receiving a first response to the meeting invitation for the first invitee and updating a first intended participation status for the first invitee based on the first response.

The method may further include updating, after an end time of the meeting, a meeting summary. The meeting summary may indicate, based on the real-time status for each of the plurality of invitees, which of the plurality of invitees attended the meeting and, where applicable, how the plurality of invitees attended the meeting.

The method may further include generating, upon updating the first real-time status, telemetry data, the telemetry data indicating when the first check-in was received and from whom the first check-in was received.

The first check-in may be received from the first invitee.

The first check-in may be received from another invitee other than the first invitee.

The first check-in may be received from a sensor.

The method may further include sending a notification to one or more of the plurality of invitees based on the first real-time status.

The first real-time status may indicate that the first invitee is currently present at a location of the meeting.

The first real-time status may indicate that the first invitee is currently in transit to attend the meeting in-person.

The first real-time status may indicate that the first invitee is not participating in the meeting.

The first check-in may be received from an application.

The first real-time status may indicate that the first invitee is currently attending the meeting virtually.

In accordance with another aspect of the present disclosure, a method is disclosed for managing reservations. The method includes maintaining a real-time status with respect to a presence at a meeting for each invitee of the meeting. The meeting has a plurality of invitees and a location. The location is reserved for the meeting. The method further includes updating the real-time status of a first invitee of the plurality of invitees based on a check-in associated with the first invitee and releasing the location for use other than for the meeting based on the real-time status for each invitee of the meeting and a policy governing use of the location.

The policy may require that the location be released if fewer than a minimum number of persons are present in-person at the meeting within an amount of time after a start time of the meeting.

The amount of time after the start time of the meeting may be zero.

The method may further include assigning the meeting to a new location based on the real-time status for each invitee of the meeting.

The method may further include sending a notification to the plurality of invitees regarding the releasing and the assigning.

In accordance with another aspect of the present disclosure, a system is disclosed for tracking participation in a meeting. The system includes one or more processors, memory in electronic communication with the one or more processors, and instructions stored in the memory. The instructions are executable by the one or more processors to send, before a start time of the meeting, a meeting invitation to a first invitee of the meeting. The instructions are further executable by the one or more processors to receive a first response to the meeting invitation for the first invitee. The first response indicates whether the first invitee intends to participate in the meeting and, if applicable, how the first invitee intends to participate in the meeting. The instructions are further executable by the one or more processors to update a first intended participation status for the first invitee based on the first response. The instructions are further executable by the one or more processors to receive a first check-in for the first invitee with respect to a presence at the meeting of the first invitee. The first check-in indicates whether the first invitee is currently participating in the meeting and, if applicable, how the first invitee is currently participating in the meeting. The instructions are further executable by the one or more processors to update a first real-time status for the first invitee based on the first check-in.

The first intended participation status and the first real-time status may be included in a participation object. The first intended participation status may indicate that the first invitee intends to attend the meeting in-person and the first check-in indicates that the first invitee is participating in the meeting virtually.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example system that facilitates tracking participation in a meeting and managing conference rooms in accordance with the present disclosure.

FIG. 2A illustrates an example person object that may be used as part of tracking participation in a meeting in accordance with the present disclosure.

FIG. 2B illustrates an example place object that may be used as part of tracking participation in a meeting in accordance with the present disclosure.

FIG. 2C illustrates an example meeting object that may be used as part of tracking participation in a meeting in accordance with the present disclosure.

FIG. 2D illustrates an example participation tracker that may be used as part of tracking participation in a meeting in accordance with the present disclosure.

FIG. 3 illustrates an example method for tracking participation in a meeting in accordance with the present disclosure.

FIG. 4 illustrates an example method for managing use of a conference room in accordance with the present disclosure.

FIG. 5 illustrates certain components that may be included within a computer system.

### DETAILED DESCRIPTION

This disclosure concerns a new data object (which may be referred to as a check-in object or a resource-usage tracker) that can be used to dynamically track planned and actual use of a physical resource. Use of this data object may improve utilization of physical resources (such as conference rooms) of an enterprise. This data object leads to increased understanding of how the physical resources of an enterprise are used and who uses the physical resources. Currently, enterprises track real-time use of electronic resources (such as websites and applications). Tracking that use can reveal trends and patterns that an enterprise can use to improve its business. The data object disclosed to herein similarly creates electronic data regarding use of physical resources that an enterprise can use to improve its business. In this way, the data object may act to create a digitized understanding of a physical resource. One application of this data object is tracking intended and actual participation in a meeting that takes place in a conference room. For that particular application, the data object also may be referred to as a participation object or a participation tracker. Other potential applications of the data object may be tracking and managing utilization of equipment, parking spaces, and private dining or party rooms (such as at a club or community facility).

An enterprise may have physical assets or resources that employees and others use in the course of performing work for the enterprise. The enterprise may also have physical assets or resources that the enterprise makes available for use as part of its business. These physical assets may not be assigned to a particular individual or set of individuals (as may be the case with individual offices) but may instead be made available for multiple individuals to use. To facilitate orderly use of the assets the enterprise may use a system that allows individuals to reserve the assets for a certain period of time. For example, the enterprise may be a business that has a physical building where employees of the enterprise work. The physical building may include conference rooms where employees can meet. The enterprise may allow employees to reserve a conference room for a particular time period. As another example, an enterprise may have a facility or physical space that has a limited capacity that customers can pay to access. Customers may be able to reserve spaces at the facility for a group at a specific time. As another example, an enterprise may have equipment. The equipment may be made available for employee use or for customer use. Employees and customers may be permitted to access the equipment by reserving the equipment for a specific time.

The enterprise may have a policy that governs use of the physical assets. The policy may be intended to maximize use of the enterprise's physical assets. For example, the enterprise may have a policy that a particular conference room cannot be reserved for meetings involving fewer than a minimum number of people. Requiring a minimum number of people for use of the particular conference room may help ensure that large conference rooms are left for use by large groups that could not fit comfortably (or at all) in smaller conference rooms. If a small group reserves a large conference room rather than a smaller one, a large group may end up not having an acceptable place to have a meeting. In that situation, the enterprise's physical assets may go underutilized, and employee productivity may suffer. As another example, an enterprise with a limited capacity facility may have a policy that during peak business hours, only groups greater than a certain size can reserve access to the facility.

The enterprise may benefit from having a policy that governs use of physical assets based on real-time use of the physical assets. Having and enforcing such a policy may further improve utilization of the physical assets. For example, consider a situation where a meeting involves many people and, as a result, a large conference room is reserved. But assume only a small number of the people who were invited to the meeting come to the large conference room for the meeting. If the meeting is scheduled to last for two hours, moving the meeting to a smaller conference room and releasing the large conference room for others to use may improve conference-room utilization. A large group may end up needing, last minute, a large conference room during the second hour of the previously scheduled meeting. If the large conference room has been released, the large group may be able to see in a reservation system that the room is available and proceed to use the room. If the large conference room has not been released, the large group may not be able to find a room to accommodate them, and employee productivity may suffer as a result.

An enterprise may efficiently and effectively enforce policies governing use of physical resources through use of a check-in object. The check-in object may track intended and actual use of a resource. For example, in the case of tracking conference-room usage, the check-in object may track participation in a meeting for each invitee of the meeting through the whole lifecycle of the meeting. The check-in object may act as a repository for three categories of information.

First, the check-in object may track intended use of the resource. For example, the check-in object may include information about whether each invitee to a meeting intends to participate in the meeting and, as applicable, how the invitee intends to participate in the meeting. Invitees may receive an electronic invitation through email or through a calendar application or system. The invitation may ask that the invitee respond to the invitation. The invitation may request that the invitee indicate whether the invitee will attend the meeting and how the invitee will attend the meeting (such as in-person or through videoconference or telephone). For each invitee, the check-in object may maintain an intended participation status and update the intended participation status based on information the invitee provides. In other applications, information about the intended use of a resource may not be based on responses to an invitation but may instead be based on an individual or individuals acting to reserve use of a resource.

The intended participation statuses may allow the enterprise to enforce policies regarding reservations of rooms. The policies may prohibit a meeting organizer from reserving a room (or maintaining a reservation for a room) if a minimum number of invitees do not indicate that they will attend the meeting in person. The policy could also require that a room with audio visual equipment be reserved if an invitee indicates that the invitee will attend through videoconference.

Second, the check-in object may include real-time information about current and actual use of the resource. For example, the check-in object may include real-time information about whether each invitee is, at the time of the meeting, actually participating in the meeting and, as applicable, how each invitee is actually participating in the meeting. In contrast to the first category of information, which concerns intended participation and may be based on information received before the meeting, this category of information concerns actual participation and may be based on information received in real-time as the meeting is about to begin and as it takes place. The check-in object may store a real-time status for each invitee. In this way, the check-in object may store information about the identities of the individuals who are participating in the meeting as opposed to just information about whether there are people at the location of the meeting or about how many individuals are at the meeting.

Invitees may provide information about their presence (or lack of presence) at the meeting, and the check-in object may update the real-time statuses for invitees based on received information. For example, invitees may be able to indicate that they have physically arrived at a location of the meeting, that they have physically left the location of the meeting, that they are running late but are on their way to attend the meeting in-person, that they have joined the meeting over the phone, or that they have joined the meeting by video conference. The check-in object may update the real-time status for each of the invitees as it changes. In this way, the check-in object may provide a way to determine in real-time who is participating in a meeting and how they are participating in the meeting. Invitees may use electronic devices (such as a mobile phone) to access a calendar system and check-in to the meeting. Equipment in the conference room where the meeting is taking place or a collaboration program that allows invitees to attend the meeting virtually may automatically check-in invitees as participating in the meeting.

The real-time statuses may allow the enterprise to enforce policies regarding use of rooms. For example, the enterprise may require that a room reservation be released if fewer than a minimum number of invitees check-in as attending in-person within a defined number of minutes of a start of the meeting. The check-in object may provide a means for the enterprise to electronically monitor real-time meeting attendance and enforce its policies regarding room use. For example, if fewer than the minimum number of invitees check-in to the meeting, the conference room being used for the meeting may be released for others to use.

The real-time statuses and the intended participation statuses may allow the calendar system to notify the invitees when they should start the meeting. For example, the calendar system may know, based on the real-time statuses and the intended participation statuses, when everyone who indicated that they intended to participate in the meeting has checked-in as currently participating in the meeting. At that time, the calendar system could send a notification to the invitees (or the checked-in invitees) that the meeting should begin.

Third, the check-in object may include summary information about use of the resource. In the meeting application, the summary information may indicate who attended the meeting and where the meeting was held. The summary information may indicate how each invitee intended to participate in the meeting and how each invitee actually participated in each meeting. The summary information may also indicate documents that were circulated in connection with the meeting. The summary information may also include transcriptions of or notes regarding the meeting. The transcriptions and notes may be automatically generated based on a recording of the meeting. Knowing who attended the meeting and how they attended the meeting may facilitate automatically creating transcriptions and notes that assign statements or ideas to particular individuals. The summary information may facilitate efficient analysis of how the enterprise's physical resources are being used. The summary information may also make it easier to document meetings.

Changes to the check-in object may generate telemetry data. The telemetry data may include information about what changes were made to the check-in object, when those changes were made, and who made those changes or who or what provided the information that prompted those changes. The telemetry data may include information that would be difficult to collect and manage manually without the use of the check-in object. The telemetry data may reveal information about resource use that would be difficult to discover without use of the check-in object. The telemetry data may be used to help improve resource utilization. The summary information included in the check-in object may be generated in part based on the telemetry data.

The check-in object may be used to track and analyze the entire life cycle of a meeting instead of focusing on a particular moment in time. Moreover, the check-in object may track participation on a per-individual basis rather than tracking just aggregate participation. In other words, the check-in object may track who attended and not just how many people attended.

The check-in object may be distinct and separate from a meeting object that represents the meeting associated with the check-in object. This separation may facilitate analysis of resource utilization while minimizing data privacy concerns. This separation may also allow for more efficient trigger conditions. A calendar system can watch fewer signals to determine whether certain conditions have been met than would be necessary without a separate check-in object.

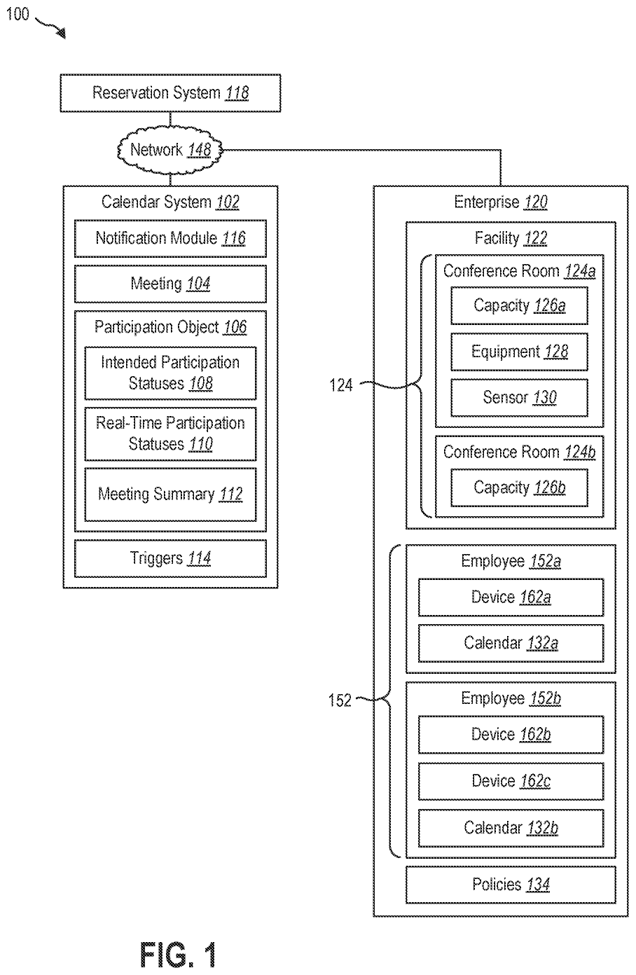

FIG. 1 shows an example system 100 in which the disclosed systems and methods may be utilized. The system 100 may include an enterprise 120, a calendar system 102, and a reservation system 118. The system 100 may include a network 148. The calendar system 102, the reservation system 118, and the enterprise 120 may be connected to and have access to the network 148. Although the reservation system 118 is shown as separate from the calendar system 102, in other designs a reservation system and a calendar system may be combined. Moreover, in other designs, a reservation system and a calendar system may be part of an enterprise.

The calendar system 102 may be an electronic system or application that manages individual calendars. The calendars may be associated with people, organizations, or accounts. For example, the enterprise 120 may use the calendar system 102 to manage calendars of employees, such as employees 152, of the enterprise 120. The calendar system 102 may exist on a cloud-computing system or on a local server.

The calendars may include events and reminders. One type of event that may be included in the calendar system 102 is a meeting 104. The meeting 104 may be scheduled to take place on a certain date and at a certain time. The meeting 104 may be scheduled to last for a specified period of time and to occur at a specified location. The meeting 104 may include invitees. The meeting 104 may appear on calendars associated with each invitee.

The calendar system 102 may allow a user to create the meeting 104 and send invitations to the invitees notifying them of the meeting 104 and requesting their participation. The invitations may ask the invitees to indicate in response whether the invitees intend to participate in the meeting 104 and indicate how the invitees intend to participate in the meeting 104. The invitees may specify in response to the invitations that they do not intend to participate in the meeting 104. The invitees may specify in response to the invitations that they intend to participate in the meeting 104 by attending in-person or by participating through video conference or telephone. The calendar system 102 may receive responses to the invitations.

The calendar system 102 may be designed to receive information regarding an invitee's real-time status with respect to actual participation in the meeting 104. Information about the invitee's real-time status may not be received in response to the invitation to participate in the meeting 104. Instead, the calendar system 102 may receive information about the invitee's real-time status dynamically as the meeting 104 is about to begin and as it takes place. Invitees may be able to check-in to the meeting 104 and indicate that they are ready to participate in the meeting 104 and indicate how they are participating in the meeting 104. For example, the invitees may indicate that they are physically present at the location of the meeting 104, that they are coming to the location of the meeting 104 but are late or will not arrive by the start time of the meeting 104, that they are on the phone, or that they are on video conference. An invitee may also check-in to the meeting 104 by indicating that the invitee is not participating in the meeting 104.

What an invitee indicates about the invitee's real-time status with respect to participating in the meeting 104 may be different from what the invitee originally indicated in response to the invitation to participate in the meeting 104. For example, an invitee may indicate in response to the invitation to participate in the meeting 104 that the invitee will attend the meeting 104 in-person. But when the invitee checks-in to the meeting 104, the invitee may indicate that the invitee is not participating in the meeting 104 or is participating by video conference.

To utilize and track information about participation in the meeting 104 the calendar system 102 may include a participation object 106. The participation object 106 may be a data object that acts as a repository for information regarding each invitee's intended and actual participation in the meeting 104. The participation object 106 may be associated with the meeting 104. Although FIG. 1 shows only the participation object 106 and the meeting 104, the calendar system 102 may include a plurality of meetings and participation objects. Each meeting may have an associated participation object, and each participation object may be associated with a single meeting.

The participation object 106 may include three categories of information.

First, the participation object 106 may include information about each invitee's intended participation in the meeting 104. To track information about each invitee's intended participation in the meeting 104 the participation object 106 may include intended participation statuses 108. The intended participation statuses 108 may include an intended participation status for each invitee of the meeting 104. The intended participation statuses 108 may reflect or include information about how each invitee responded to the invitation to the meeting 104. The intended participation statuses 108 may specify whether each invitee intends to participate in the meeting 104 and how each invitee intends to participate in the meeting 104. The intended participation statuses 108 may be based on the invitees' responses to a meeting invitation.

Second, the participation object 106 may include information about each invitee's actual participation in or presence at the meeting 104. To track information about each invitee's actual participation in the meeting 104 the participation object 106 may include real-time participation statuses 110. The real-time participation statuses 110 may include a real-time participation status for each invitee of the meeting 104. The real-time participation statuses 110 may reflect or include information about whether an invitee is actually participating in the meeting 104 and how the invitee is actually participating in the meeting 104. The calendar system 102 may base the real-time participation statuses 110 on check-ins received from invitees. The invitees may also modify the real-time participation statuses 110 by checking-in to the meeting. The real-time participation statuses 110 may act as a state machine with respect to the actual participation of the invitees.

Checking-in to the meeting 104 may involve an invitee (or someone else) communicating to the calendar system 102 the invitee's current status with respect to participating in the meeting 104. For example, the invitee may communicate to the calendar system 102 that the invitee is actually participating in the meeting 104 or that the invitee is not participating in the meeting 104. The invitee may communicate to the calendar system 102 that the invitee is currently participating in the meeting by attending in-person, attending by phone, or attending through video conference. The invitee may also communicate to the calendar system 102 that the invitee is on the way to attend the meeting 104 in-person or will be calling into the meeting 104 in 10 minutes. The invitee may communicate to the calendar system 102 using an application (such as a calendar application) on a computing device or through electronic messages (such as email messages or text messages) sent using a computing device. The real-time participation statuses 110 may have a discrete number of states and the invitees may be able to set and modify the states of the real-time participation statuses 110.

Checking-in to the meeting 104 may involve an invitee (or someone else) communicating to the calendar system 102 the invitee's physical location. For example, checking-in to the meeting 104 may include an invitee indicating that the invitee is in a lobby of a building where the meeting 104 is set to take place. As another example, checking-in to the meeting 104 may include an invitee who is in transit to the meeting indicating the invitee's current location. The calendar system 102 may have access to a map program and may obtain information about the invitee's distance from the location of the meeting 104. The calendar system 102 may use that information in updating the real-time participation status associated with the invitee. The calendar system 102 may also use that information in determining when the meeting 104 should start.

Checking-in to the meeting 104 may involve an application or system communicating with the calendar system 102. For example, an invitee may join the meeting 104 through video conference using a video conference or collaboration program. When the invitee logs in and joins the meeting 104 using the program, the program may communicate with the calendar system 102 and alert the calendar system 102 that the invitee is participating in the meeting through video conference. The calendar system 102 may modify the real-time participation statuses 110 to reflect that the invitee is currently participating in the meeting through video conference. As another example, a facial-recognition system or Bluetooth system may detect that an invitee or a device associated with the invitee has entered the location of the meeting 104 and automatically check-in the invitee as being present in-person at the meeting 104.

Third, the participation object 106 may include a meeting summary 112. The meeting summary 112 may summarize information about the meeting 104 and participation in the meeting 104. For example, the meeting summary 112 may indicate where the meeting 104 took place, who attended the meeting 104, how each individual attended the meeting 104, and what each individual said about how they intended to participate (or not participate) in the meeting 104. The meeting summary 112 may also indicate whether any triggers occurred during the meeting 104. For example, the meeting summary 112 may indicate whether the location of the meeting 104 was released because an insufficient number of invitees checked-in as attending the meeting 104 in-person.

Information in the meeting summary 112 (and the participation object 106) may allow the enterprise 120 to learn the meeting participation habits of employees of the enterprise 120. For example, the enterprise 120 may learn what groups of employees frequently participate in in-person meetings. The enterprise 120 may use that information in determining where offices of those employees should be located. As another example, the enterprise 120 may learn who frequently states that the person intends to participate in a meeting but ultimately does not participate in the meeting. Such information may be useful for a meeting organizer in determining whether to start a meeting. The meeting organizer may start the meeting even though an employee who indicated the employee would participate has not yet checked-in if the employee frequently fails to come to meetings.

The meeting summary 112 may include transcriptions or notes regarding the meeting 104. An application or equipment (such as the equipment 128) may create an audio or audio-visual recording of the meeting 104. An application, equipment, or a person may create a transcription of or notes regarding the meeting 104. Having information about who participated in the meeting 104 and how they participated in the meeting 104 may facilitate attributing particular statements or ideas to specific individuals. For example, an application used to create automatic transcriptions of meeting recordings may be able to learn voice identities based on knowledge about who participated in the meetings and how they participated.

The calendar system 102 may include triggers 114. The triggers 114 may be used to cause the calendar system 102 to take specific actions in response to defined conditions. The actions may involve sending a notification. The actions may involve causing some change with respect to a reservation for the location of the meeting 104. The triggers 114 may be designed to watch one or more signals, such as the real-time participation statuses 110, and determine whether the one or more signals satisfy a condition (or fail to satisfy a condition). The triggers 114 may be designed such that the triggers 114 cause the calendar system 102 to take a predetermined action when the one or more signals satisfy (or fail to satisfy) the condition.

For example, the triggers 114 may include a condition that for the location of the meeting 104, at least five individuals must be checked-in as physically present at the meeting 104 within 10 minutes of the start time of the meeting 104. To determine whether the condition is satisfied the triggers 114 may monitor the real-time participation statuses 110 of the participation object 106 associated with the meeting 104. A predetermined action associated with that condition may be to cause the location of the meeting 104 to be released for use by others. Performing the predetermined action may include communicating with the reservation system 118.

As another example, the triggers 114 may monitor the real-time participation statuses 110 of the participation object 106 to determine whether certain invitees have checked-in as participating in the meeting (whether in-person or virtually). The certain invitees may be particular individuals or may be all the invitees that indicated in response to the meeting invitation that they intended to participate in the meeting 104. When the triggers 114 determine that occurs, the triggers 114 may cause the calendar system 102 to send a notification to invitees to begin conducting the meeting 104. As another example, where the real-time participation status 110 indicates that an invitee is within five minutes of the location of the meeting 104, the calendar system 102 may notify the invitees to wait to begin conducting the meeting 104.

The triggers 114 may also use information received from invitees in response to notifications. For example, the calendar system 102 may send a notification to an invitee who has not yet checked-in to the meeting 104 asking whether the meeting 104 should begin without the invitee. If the invitee responds “yes,” the triggers 114 may cause the calendar system 102 to send a notification for the invitees to begin the meeting 104. If the invitee responds “no” or that the invitee will arrive in five minutes, the calendar system 102 may send a notification for the invitees to wait to begin the meeting 104.

The triggers 114 may have access to information about whether an invitee has indicated in an email application that the invitee is out of the office. The triggers 114 may include conditions that consider the out-of-office status of an invitee. For example, the out-of-office status of an invitee may inform whether the triggers 114 cause the calendar system 102 to send a notification to start the meeting 104 even though the invitee has not yet checked-in to the meeting 104.

To send notifications to invitees the calendar system 102 may use a notification module 116. The notification module 116 may allow the calendar system 102 to send information and requests for information to invitees of the meeting 104. For example, the notification module 116 may send meeting invitations to invitees of the meeting 104. The notification module 116 may send notices to a meeting organizer when an invitee responds to the meeting invitation or when an invitee checks-in to the meeting 104. The notification module 116 may send notices to a meeting organizer or the invitees when an invitee checks-in as being present in a lobby of a building where the meeting 104 is set to take place. At a start of the meeting 104, the notification module 116 may send a request that invitees check-in to the meeting 104. The notification module 116 may send such requests to only those invitees who have not yet checked-in to the meeting 104. The notification module 116 may send notifications about when, based on the intended participation statuses 108, the real-time participation statuses 110, and other information, the invitees should begin conducting the meeting 104. The notification module 116 may send notices warning that the location of the meeting 104 may be released for others to use unless additional invitees check-in as being present at the meeting 104. The notification module 116 may send notices when the location of the meeting 104 has been released. The notification module 116 may send notices when the meeting 104 has been reassigned to a new location. The notification module 116 may send a request for a check-in when a sensor at the location of the meeting 104 detects a presence of a person at the location but does not have a capability to determine an identity of the person.

The notifications may request a response. For example, at the time the meeting 104 is scheduled to start, the notification module 116 may send notifications to any invitees who indicated that they intended to participate in the meeting but who have not yet checked-in. The notifications may ask whether the other invitees should begin the meeting 104 without them. The notifications may ask whether the invitees want to join the meeting 104 online (even if the invitees indicated that they intended to participate in the meeting 104 by attending in-person). The notifications may ask the invitees whether they still intend to participate in the meeting 104 and to specify how long until the invitees can join the meeting 104. The notifications may provide the invitees a means to respond to the notifications. In the alternative, the invitees may respond by accessing an application, such as a calendar application or an email application.

The enterprise 120 may have physical resources and assets. Employees of the enterprise 120 and others may utilize the physical resources of the enterprise 120. One example of a physical resource of the enterprise may be a facility 122. The facility 122 may be a physical facility that includes conference rooms 124.

Conference room 124a may have a capacity 126a, a sensor 130, and equipment 128.

The capacity 126a may be a measure of how large in terms of physical area the conference room 124a is and how many individuals can comfortably meet in-person in the conference room 124a. The capacity 126a may be measured in number of people. For example, the capacity 126a may be 20 people.

The sensor 130 may be a device capable of detecting or measuring properties of the conference room 124a. For example, the sensor 130 may be a motion sensor and detect movement in the conference room 124a. The sensor 130 may be an occupancy sensor that detects when at least one individual is present in the conference room 124a. The sensor 130 may be capable of detecting how many individuals are present in the conference room 124a. The sensor 130 may be capable of performing facial recognition. The sensor 130 may be a Bluetooth sensor that can recognize a particular device. The calendar system 102 may be able to associate the particular device with a specific user.

The equipment 128 may be equipment useful for conducting the meeting 104. For example, the equipment 128 may include a phone, a display screen, a computer, audio/visual equipment, videoconferencing equipment, a touchscreen interface, or a recording device.

Conference room 124b may have a capacity 126b. The capacity 126b of the conference room 124b may be less than the capacity 126b of the conference room 124b. The conference room 124b may not include a sensor or audio/visual equipment.

The enterprise 120 may use the reservation system 118 to manage use of the conference rooms 124. The reservation system 118 may allow individuals to reserve the conference rooms 124 on a specified date for a specified period of time. The reservation system 118 and the calendar system 102 may communicate with each other. For example, consider a situation where an individual creates the meeting 104 in the calendar system 102 and specifies that the meeting 104 will be held at the conference room 124a. The calendar system 102 may automatically request that the reservation system 118 reserve, for a duration of the meeting 104, the conference room 124a. The calendar system 102 may also not permit an individual to specify the conference room 124a as the location for the meeting 104 if the conference room 124a is not available in the reservation system 118.

The enterprise 120 may have policies 134 regarding use of the conference rooms 124. The policies 134 may provide conditions that must be satisfied in order to reserve the conference rooms 124, use the conference rooms 124, or maintain a reservation for the conference rooms 124. For example, the policies 134 may specify a minimum number of individuals that must be invited to a meeting in order to reserve the conference room 124a. The policies 134 may specify a minimum number of individuals that must be present in-person at a meeting in order to maintain a reservation for the conference room 124a. The triggers 114 may be based in part on the policies 134.

Employee 152a of the enterprise 120 may have a device 162a and a calendar 132a. The device 162a may be any computing device. The employee 152a may use the device 162a to access an electronic representation of the calendar 132a (which may be stored in the calendar system 102), schedule meetings, reserve conference rooms, respond to meeting invitations, receive notifications, and check-in to meetings. For example, the employee 152a may use the device 162a to schedule the meeting 104 or receive notifications related to the meeting 104. The employee 152a may use the device 162a to access the calendar system 102, send requests to the calendar system 102, or receive requests or notifications from the calendar system 102. The employee 152a may use the device 162a to access the reservation system 118. The employee 152a may, upon arriving at the meeting 104, use the device 162a to check-in as physically present at the meeting 104.

Similarly, the employee 152b may have devices 162b, 162c and a calendar 132b. The employee 152b may be able to access the calendar system 102 and the reservation system 118 from the devices 162b, 162c. The device 162b may be a mobile device while the device 162c may not be designed for mobile use.

The real-time participation statuses 110, the triggers 114, and the notification module 116 may help the invitees know when to start conducting the business of the meeting 104 and when to wait to start the meeting 104. In this way, the real-time participation statuses 110, the triggers 114, and the notification module 116 may help the enterprise 120 make more efficient use of physical resources and assets (including the conference rooms 124).

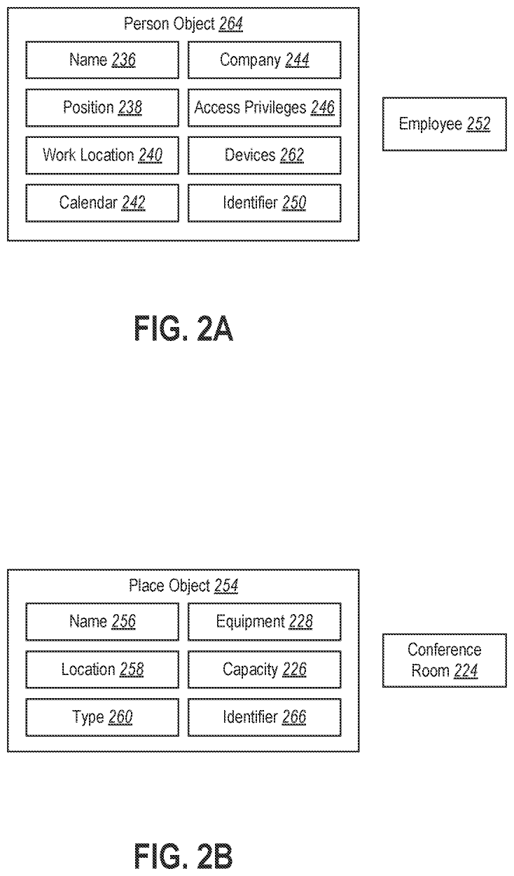

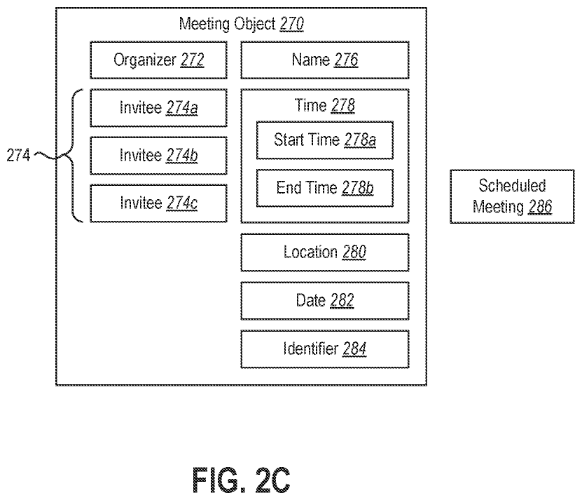

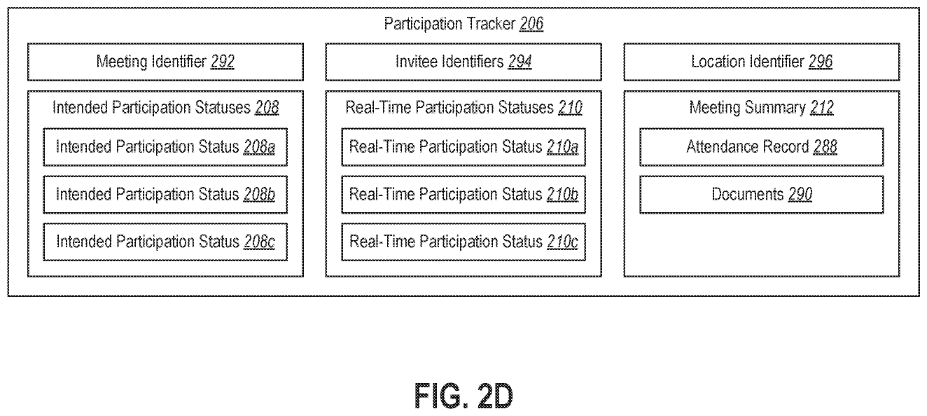

FIG. 2A illustrates an example person object 264. The person object 264 may be an electronic record representing an actual person, such as an employee 252 of an enterprise. The employee 252 may have a name and a position in the enterprise. The employee 252 may work at a location and use one or more devices in performing work for the enterprise. In the alternative, the person object 264 may be an electronic record representing a user account. The user account may be associated with an actual person or an entity.

The person object 264 may include a name 236, a company 244, a position 238, a work location 240, devices 262, access privileges 246, a calendar 242, and an identifier 250. The name 236 of the person object 264 may be based on the name of the employee 252. In the alternative, the name 236 of the person object 264 may be a username created by or assigned to a user. The position 238 of the person object 264 may be based on the position of the employee 252 in the enterprise. The company 244 of the person object 264 may identify the enterprise for which the employee 252 works. The work location 240 of the person object 264 may represent and be based on the location at which the employee 252 works. The access privileges 246 of the person object 264 may specify what actions the person object 264 can take with respect to a system, such as the reservation system 118 or the calendar system 102. For example, the access privileges 246 may specify whether the person object 264 may reserve a conference room, such as the conference room 124a. The devices 262 of the person object 264 may identify zero or more devices associated with the person object 264. The devices 262 may be computing devices, such as a mobile phone, a tablet, a laptop, or a desktop computer. The calendar 242 may connect the person object 264 to an electronic calendar associated with the person object 264. The identifier 250 of the person object 264 may be a unique identifier assigned to the person object 264 that uniquely identifies the person object 264 as compared to other objects in a system.

FIG. 2B illustrates an example place object 254. The place object 254 may be an electronic record representing an actual place, such as a conference room 224. The conference room 224 may be a place managed by an enterprise. The conference room 224 may be a defined physical area used for meetings. The conference room 224 may have physical equipment associated with it, such as a phone, a white board, a projector, or a display screen.

The place object 254 may have a name 256, a location 258, a type 260, equipment 228, a capacity 226, and an identifier 266. The name of the place object 254 may be based on a name of the conference room 224. The location 258 of the place object 254 may represent or indicate an actual location of the conference room 224. The equipment 228 of the place object 254 may indicate any equipment that may be associated with the conference room 224. The capacity 226 of the place object 254 may indicate a physical size of the conference room 224. The type 260 of the place object 254 may indicate the type of place represented by the place object 254. Some example types of places may include conference rooms, offices, office buildings, parking spaces, parking lots, warehouses, and cafeterias. For the place object 254 shown in FIG. 2B, the type 260 may indicate conference room.

FIG. 2C illustrates an example meeting object 270. The meeting object 270 may be an electronic record representing an actual meeting, such as a scheduled meeting 286. The scheduled meeting 286 may be scheduled for a particular date and time. The scheduled meeting 286 may be scheduled to last for a certain amount of time. The scheduled meeting 286 may be scheduled to take place at a particular location, such as the conference room 224. Certain individuals, such as the employee 252, may be invited to participate in the scheduled meeting 286. The meeting object 270 may exist in a calendar system, such as the calendar system 102 shown in FIG. 1.

The meeting object 270 may include a name 276, an organizer 272, invitees 274, a time 278, a date 282, a location 280, and an identifier 284. The name 276 of the meeting object 270 may be based on a name given to the scheduled meeting 286. The organizer 272 may indicate a person who organized the scheduled meeting 286. The organizer 272 may include information associating the organizer 272 with a person object that represents the organizer 272. The invitees 274 may indicate persons who are invited to attend the scheduled meeting 286. The invitees 274 may include information associating the invitees 274 to person objects that represent the invitees 274. The invitees 274 may be employees of an enterprise. The invitees 274 may include persons who are not employees of the enterprise. The time 278 may indicate a start time 278a and an end time 278b for the scheduled meeting 286. The date 282 may indicate a day and year on which the scheduled meeting 286 is to take place. The location 280 may indicate a place where the scheduled meeting 286 is to take place. The location 280 may include information associating the location 280 with a place object that represents the location 280.

FIG. 2D illustrates an example participation tracker 206. The participation tracker 206 may be a data object. The participation tracker 206 may exist in a calendar system used by an enterprise. The participation tracker 206 may be used by the calendar system to track the intended and actual participation in the scheduled meeting 286 of each of the invitees 274. The participation tracker 206 may be a data object separate from the meeting object 270, the place object 254 that may represent the location 280 of the scheduled meeting 286, and any person objects that may represent the invitees 274. That the participation tracker 206 is separate from the meeting object 270 may mean that the calendar system can place different levels of access control on the participation tracker than the meeting object 270. It may also mean that the calendar system can watch signals associated with the participation tracker 206 without having to go through the meeting object 270.

The participation tracker 206 may include a meeting identifier 292. The participation tracker 206 may be associated with the meeting object 270. The participation tracker 206 may be associated with only the meeting object 270 and not any other meeting objects. The meeting identifier 292 may connect the participation tracker 206 to the meeting object 270. The meeting identifier 292 may include the name 276 of the meeting object 270, the identifier 284 of the meeting object 270, or other information that identifies the meeting object 270. The participation tracker 206 or the calendar system may use the meeting identifier 284 to access the meeting object 270 and information contained in the meeting object 270.

The participation tracker 206 may include invitee identifiers 294. The invitee identifiers 294 may identify the invitees 274 included in the meeting object 270. The invitee identifiers 294 may point the participation tracker 206 to person objects that represent the invitees 274 included in the meeting object 270. The participation tracker 206 or the calendar system may use the invitee identifiers 294 to access the person objects that represent the invitees 274 and information contained in those person objects.

The participation tracker 206 may include a location identifier 296. The location identifier 296 may identify the place object 254 associated with the location 280 included in the meeting object 270. The location identifier 296 may point the participation tracker 206 to the place object 254 that represents the location 280 included in the meeting object 270. The participation tracker 206 or the calendar system may use the location identifier 296 to access the place object 254 and information contained in the place object 254.

The participation tracker 206 may include intended participation statuses 208. The intended participation statuses 208 may include information about whether the invitees 274 intend to participate in the scheduled meeting 286 and information about how the invitees 274 intend to participate in the scheduled meeting 286. The intended participation statuses 208 may be limited to certain states, and the invitees 274 or others may change the intended participation statuses 208 to reflect the intentions of the invitees 274 with respect to participating in the scheduled meeting 286. The participation tracker 206 may include an intended participation status for each of the invitees 274 included in the meeting object 270. Intended participation status 208a may be associated with invitee 274a, intended participation status 208b may be associated with invitee 274b, and intended participation status 208c may be associated with invitee 274c.

The intended participation statuses 208 may be based on or reflect responses to invitations to participate in the scheduled meeting 286. For example, the invitee 274a may receive an invitation to participate in the scheduled meeting 286. The invitee 274a may receive the invitation through email or an application. The invitee 274a may initially specify in response to the invitation that the invitee 274a will not be participating in the scheduled meeting 286. The intended participation status 208a may be updated to reflect that response. For example, the intended participation status 208a may be set initially at a default state of “Unknown” and then be changed to “Not Participating.” The invitee 274a may initially specify that the invitee 274a will not be participating because the invitee 274a may have another, higher priority meeting set for the same time as the scheduled meeting 286. At some later point, however, the another, higher priority meeting may be cancelled. The invitee 274a may, at that point, specify that the invitee 274a intends to attend the scheduled meeting 286 in-person. The invitee 274a may do so by updating the response to the meeting invitation. The intended participation status 208a may update to indicate that the invitee 274a will participate in the scheduled meeting 286 by attending in-person.

There may be a cut-off time for modifying the intended participation statuses 208. For example, the calendar system or the participation tracker 206 may prohibit modifications to the intended participation statuses 208 at the start time 278a of the scheduled meeting 286. In the alternative, the calendar system or the participation tracker 206 may prohibit modifications to the intended participation statuses 208 at a predefined time before the start time 278a of the scheduled meeting 286.

The participation tracker 206 may include real-time participation statuses 210. The real-time participation statuses 210 may indicate whether each of the invitees 274 is currently participating in the scheduled meeting 286 and how each of the invitees 274 is currently participating in the scheduled meeting 286. Stated another way, the real-time participation statuses 210 may indicate the current status of each of the invitees 274 with respect to participating in the scheduled meeting 286. The real-time participation statuses 210 may include a real-time participation status for each of the invitees 274 included in the meeting object 270. Real-time participation status 210a may be associated with the invitee 274a, real-time participation status 210b may be associated with the invitee 274b, and real-time participation status 210c may be associated with the invitee 274c. The real-time participation statuses 210 may be limited to certain states, and the invitees 274 or others may change the real-time participation statuses 210 to reflect their current status with respect to actual participation (or non-participation) in the scheduled meeting 286.

The real-time participation statuses 210 may be based on information received or obtained before or during the scheduled meeting 286.

The real-time participation statuses 210 may be based on responses received to the invitation to participate in the scheduled meeting 286. For example, the invitee 274b may have, in response to an invitation to the scheduled meeting 286, indicated that the invitee 274b would not participate in the scheduled meeting 286. Based on that response, the real-time participation status 210b for the invitee 274b may be set to a default value indicating that the invitee 274b is not participating in the scheduled meeting 286. The real-time participation status 210b may not be set to such a default value until a predetermined time before the start time 278a of the scheduled meeting 286. In addition or in the alternative, the real-time participation status 210b may communicate that the invitees 274a, 274c should not expect the invitee 274b to participate in the scheduled meeting 286. In the alternative, the real-time participation status 210b may communicate that the invitees 274a, 274c should not wait for the invitee 274b to participate in the scheduled meeting 286.

The real-time participation statuses 210 may be based on information received from the invitees 274 or others. The invitees 274 or other persons may cause the real-time participation statuses 210 to change by checking-in to the scheduled meeting 286. Checking-in to the scheduled meeting 286 may involve the invitees 274 indicating to the calendar system current participation statuses of the invitees 274 with respect to actual participation in the scheduled meeting 286. For example, the invitee 274c may check-in as having arrived at the conference room 224. The invitee 274c may do so using a mobile device or a computing device or input device present in the conference room 224. Checking-in as having arrived at the conference room 224 may cause the real-time participation status 210c to indicate that the invitee 274c is currently at the scheduled meeting 286. As another example, the invitee 274c may use a computing device to check-in as five minutes away from the conference room 224. In that case, the real-time participation status 210c of the invitee 274c may indicate that the invitee 274c will be at the scheduled meeting 286 shortly or will be at the scheduled meeting in five minutes. As another example, the invitee 274c may use a computing device to check-in as on the phone. The real-time participation status 210c may indicate that the invitee 274c is currently participating in the scheduled meeting 286 through the phone. Similarly, the invitee 274c may check-in as calling into the scheduled meeting 286 in 10 minutes, and the real-time participation status 210c may reflect that information. As another example, at the start time 278a of the scheduled meeting 286, the invitee 274c may check-in as not participating in the scheduled meeting 286. The invitee 274c may do so even though the invitee 274c indicated in response to a meeting invitation that the invitee 274c would be attending the scheduled meeting 286 in-person. In that case, the real-time participation status 210c of the invitee 274c may indicate that the invitee 274c is not participating in the scheduled meeting 286. Having the real-time participation status 210c indicate that the invitee 274c is not participating in the scheduled meeting 286 may be different from the real-time participation status 210c indicating that it is unknown whether the invitee 274c is currently participating in the scheduled meeting 286, that the invitee 274c may be participating in the scheduled meeting 286, or that the invitee 274c is in transit to the scheduled meeting 286. As another example, the invitee 274a may be at the conference room 224 for the scheduled meeting 286 and see the invitee 274c enter the conference room 224 for the scheduled meeting 286. The invitee 274a may check-in the invitee 274c to the scheduled meeting 286. The real-time participation status 210c of the invitee 274c may indicate that the invitee 274c is present in-person at the scheduled meeting 286.

The real-time participation statuses 210 may be based on information received from sensors. For example, the conference room 224 may include a facial-recognition sensor and may provide information to a calendar system about who is present in the conference room 224. If the facial-recognition sensor senses the invitee 274a in the conference room 224, the real-time participation status 210a may indicate that the invitee 274a is at the conference room 224 and participating in the scheduled meeting 286. As another example, the conference room 224 may include a Bluetooth sensor that can identify a particular device. If the Bluetooth sensor detects a device, a system may determine that the device is associated with a particular individual (such as the employee 252). The system may then check-in the particular individual as being present at the scheduled meeting 286.

The real-time participation statuses 210 may be based on information received from applications. For example, the invitee 274b may attend the scheduled meeting 286 by videoconference using a collaboration application. The collaboration application may, upon the invitee 274b joining the scheduled meeting 286 by videoconference, notify the calendar system that the invitee 274b is present at the meeting and is participating by videoconference.

The real-time participation statuses 210 may change during the scheduled meeting 286. For example, the invitee 274c may, at a beginning of the scheduled meeting 286, check-in as being present in-person at the scheduled meeting 286. The invitee 274c may, however, leave the scheduled meeting 286 halfway through the scheduled meeting 286. At that time, the invitee 274c may check-in as being absent from the scheduled meeting 286.

There may be a cut-off time for modifying the real-time participation statuses 210. For example, the calendar system or the participation tracker 206 may prohibit modifications to the real-time participation statuses 210 at the end time 278b of the scheduled meeting 286. In the alternative, the calendar system or the participation tracker 206 may prohibit modifications to the real-time participation statuses 210 at a predefined time after or before the end time 278b of the scheduled meeting 286.

The calendar system or the participation tracker 206 may prohibit modifications to the real-time participation statuses 210 until a certain time. For example, the calendar system or the participation tracker 206 may not allow modifications to the real-time participation statuses 210 until a predefined time before the start time 278a of the scheduled meeting 286.

The calendar system may include triggers that use the real-time participation statuses 210. The triggers may include pairs of conditions and actions. The triggers may specify that when one or more conditions are satisfied, the calendar system should perform one or more specified actions. The triggers may specify that when the one or more conditions are not satisfied, the calendar system should perform one or more specified actions. For example, a condition may be that a predefined number of people check-in as participating in the scheduled meeting 286 in-person by the start time 278a of the scheduled meeting 286. The triggers may specify that if the condition is not satisfied, the calendar system takes the following action—cause the location 280 of the scheduled meeting 286 to be released for use by others. The triggers may also specify that if the condition is not satisfied, the calendar system causes a notification to be sent to the invitees that the location 280 is being released for use by others. As another example, the triggers may include conditions that control when the calendar system notifies invitees to begin the scheduled meeting 286. For example, consider a situation where the intended participation status 208a and the intended participation status 208b both indicate that the invitee 274a and the invitee 274b intend to attend the scheduled meeting 286 in-person. The intended participation status 208c may indicate that the invitee 274c does not intend to participate in the scheduled meeting 286 in any form. The triggers may specify that the calendar system should notify the invitees 274 (or just the invitee 274a and the invitee 274b) that they should start the scheduled meeting 286 when the real-time participation status 210a and the real-time participation status 210b indicate that the invitee 274a and the invitee 274b are present at the scheduled meeting 286.

The triggers may be based on a policy (such as the policies 134) of an enterprise (such as the enterprise 120). The policy may govern use of the conference room 224. The policy may be based in part on the characteristics and attributes of the conference room 224. For example, the policy may specify a minimum number of in-person attendees that must be present at the conference room 224 in order to maintain a reservation for the conference room 224. The minimum number of in-person attendees may be based on the capacity 226 of the conference room 224. The policy may include conditions based on the type 260 of the conference room 224, the equipment 228 of the conference room 224, and the location 258 of the conference room 224.

The policy may be based in part on attributes and characteristics of the organizer 272 or the invitees 274 of the scheduled meeting 286. For example, the policy may not cancel a reservation for the conference room 224 where fewer than the minimum number of in-person attendees check-in to the scheduled meeting 286 if the organizer 272 has a certain position within the company.

The participation tracker 206 may include a meeting summary 212. The meeting summary 212 may include an attendance record 288. The attendance record 288 may summarize participation in the scheduled meeting 286. The attendance record 288 may include a count of the number of people who participated in the scheduled meeting 286. The attendance record 288 may include a count of the number of people who participated in the scheduled meeting 286 by attending in-person. The attendance record 288 may specify who attended the scheduled meeting 286 and by what means they attended the scheduled meeting 286. The attendance record 288 may specify who did not attend the scheduled meeting 286. The attendance record 288 may specify whose actual participation in the scheduled meeting 286 differed from their intended participation in the scheduled meeting 286.

The meeting summary 212 may include documents 290. The documents 290 may be electronic copies of documents or links to electronic copies of documents. Accessing the documents 290 or information about the documents 290 may require different access privileges than those required to access other parts of the participation tracker 206. The documents 290 may include a recording of the scheduled meeting 286. The documents 290 may include a post-meeting transcription. The post-meeting transcription may be a written transcription of an audio recording of the scheduled meeting 286. The post-meeting transcription may attribute specific statements to a specific invitee. An application may generate the post-meeting transcription automatically and may use the real-time participation statuses 210 or the attendance record 288 in attributing specific statements to specific invitees. The application may use information from participation trackers associated with other meetings to learn that a particular voice pattern is associated with a particular invitee. The documents 290 may include notes regarding the scheduled meeting 286. The notes may be automatically generated. The notes may include information about who attended the scheduled meeting 286 based on the real-time participation statuses 210 or the attendance record 288.

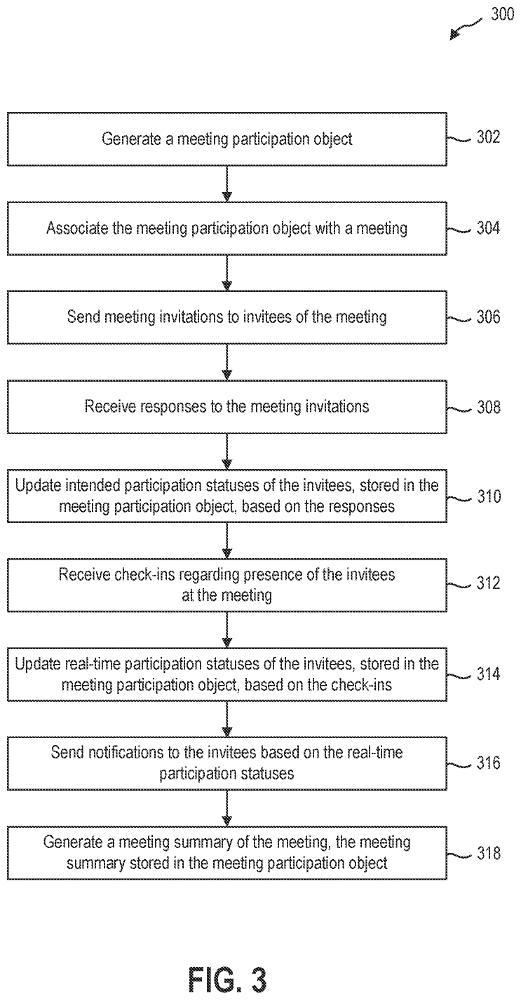

FIG. 3 illustrates an example method 300 for tracking participation in a meeting.

The method 300 may include generating 302 a meeting participation object. The meeting participation object may be the participation object 106 or the participation tracker 206. A calendar system, such as the calendar system 102, may generate the meeting participation object. The calendar system may generate the meeting participation object in response to a user creating a meeting. The calendar system may generate the meeting participation object in response to a user reserving a room using a reservation system, such as the reservation system 118.

The meeting participation object may include placeholders for intended participation statuses (such as the intended participation statuses 108 or the intended participation statuses 208). The meeting participation object may include placeholders for real-time participation statuses (such as the real-time participation statuses 110 or the real-time participation statuses 210). The meeting participation object may include a placeholder for a meeting summary (such as the meeting summary 112 or the meeting summary 212). The meeting participation object may include only one of the placeholders described above or two or more of the placeholders described above.

The method 300 may include associating 304 the meeting participation object with a meeting. The meeting may be the scheduled meeting 286. The calendar system may include a meeting object, such as the meeting object 270, that represents the meeting. The meeting may have invitees (persons invited to the meeting). The meeting object may list the invitees (such as the invitees 274). The meeting participation object may be separate from the meeting object. Having the meeting participation object be separate from the meeting object may mean that a person may be granted access to the meeting participation object but not the meeting object. Having the meeting participation object be separate from the meeting object may mean that the calendar system can access the meeting participation object without having to access the meeting object. The meeting participation object may be associated with only one meeting. It may be that every meeting (and each instance of a recurring meeting) included in the calendar system has an associated meeting participation object.

Associating 304 the meeting participation object with the meeting may include creating an intended participation status and a real-time participation status for each invitee of the meeting. The intended participation status and the real-time participation status for each invitee of the meeting may be given a null value or a default value. The default value for the intended participation status may indicate that the intended participation status of the invitee is unknown. In the alternative, the default value for the intended participation status may indicate that the calendar system is waiting for a response from the invitee. In the alternative, the default value for the intended participation status may indicate that the invitee is not intending to participate in the meeting or may participate in the meeting. The default value for the real-time participation status for the invitee may indicate that the real-time participation status is unknown. In the alternative, the default value for the real-time participation status for the invitee may indicate that the calendar system is waiting for a check-in from the invitee. In the alternative, the default value for the real-time participation status for the invitee may indicate that the invitee is not currently participating in the meeting.

The method 300 may include sending 306 meeting invitations to invitees of the meeting. The calendar system may send the meeting invitations to the invitees of the meeting. The meeting invitations may notify the invitees of the date, time, and location of the meeting. The meeting invitations may request that the invitees respond to the meeting invitations. The meeting invitations may allow the invitees to indicate in response whether the invitees intend to participate in the meeting and, if applicable, how the invitees intend to participate in the meeting.

The method 300 may include receiving 308 responses to the meeting invitations. Receiving 308 responses to the meeting invitations may include receiving responses from one or more of the invitees. The calendar system may receive the responses from the invitees. The calendar system may receive responses from invitees at different times. The calendar system may receive more than one response from an invitee. For example, the invitee may send a first response and then later send a second response that is different from the first response. The responses may indicate whether the invitees intend to participate in the meeting and, if applicable, how the invitees intend to participate in the meeting.

The invitees may respond to the meeting invitations by selecting one of a set of response options. The set of response options may represent the finite states or values that the intended participation statuses may have. In some designs, the finite states or values that the intended participation statuses may have may be a combination of two or more of the set of options. In other words, in some designs, the invitees may select more than one of the set of response options. The set of response options may include the invitee intends to participate in the meeting in person, the invitee intends to participate in the meeting virtually, the invitee intends to participate in the meeting over the phone, the invitee intends to participate in the meeting over video conference, the invitee intends to participate in the meeting but will be X number of minutes late, the invitee does not intend to participate in the meeting, the invitee may participate in the meeting, or the invitee is X % likely to participate in the meeting.

The method 300 may include updating 310 the intended participation statuses of the invitees, stored in the meeting participation object, based on the responses. The calendar system may update the intended participation statuses of the invitees. Updating 310 the intended participation statuses may include setting an initial value of the intended participation statuses. Updating 310 the intended participation statuses may include modifying the intended participation statuses from a first value to a second value. Updating 310 the intended participation statuses may include setting the value of the intended participation statuses to reflect the responses of the invitees. The calendar system may update the intended participation statuses at different times. For example, the calendar system may update a first intended participation status at a first time and later update a second intended participation status at a second time. The calendar system may update fewer than all the intended participation statuses stored in the meeting participation object.

The method 300 may include receiving 312 check-ins regarding presence of the invitees at the meeting. A check-in may indicate whether an invitee is currently participating in the meeting and, if applicable, how the invitee is currently participating in the meeting. The invitees may check-in regarding their presence at the meeting. Someone other than an invitee may check-in the invitee. A sensor or an application may check-in the invitee. The calendar system may receive the check-ins. The calendar system may receive the check-ins at different times. Receiving 312 check-ins may include receiving check-ins from one or more of the invitees or regarding one or more of the invitees. The calendar system may not receive a check-in for each invitee. The calendar system may receive more than one check-in from an invitee. For example, the invitee may provide a first check-in at the start of the meeting but later provide a second check-in during the meeting that is different from the first check-in.

The invitees may check-in to the meeting by selecting one of a set of check-in options. The set of check-in options may represent the finite states or values that the real-time participation statuses may have. In some designs, the finite states or values that the real-time participation statuses may have may be a combination of two or more of the set of check-in options. In other words, in some designs, the invitees may select more than one of the set of check-in options. The set of check-in options may include the invitee is currently attending the meeting in-person, the invitee is currently attending the meeting using the phone, the invitee is currently attending the meeting using video conference, the invitee is on the way to the meeting, the invitee will participate in the meeting in X minutes, the invitee is not participating in the meeting, the invitee is in the lobby of the building where the meeting is taking place, or the invitee has left the meeting.

The method 300 may include updating 314 real-time participation statuses of the invitees, stored in the meeting participation object, based on the check-ins. The calendar system may update the real-time participation statuses of the invitees. Updating 314 the real-time participation statuses may include setting an initial value of the real-time participation statuses. Updating 314 the real-time participation statuses may include modifying the real-time participation statuses from a first value to a second value. Updating 314 the real-time participation statuses may include setting the value of the real-time participation statuses to reflect the check-ins of the invitees. Updating 314 the real-time participation statuses may include the invitees selecting the real-time participation statuses. The calendar system may update the real-time participation statuses at different times. For example, the calendar system may update a first real-time participation status at a first time and later update a second real-time participation status at a second time. The calendar system may update fewer than all the real-time participation statuses stored in the meeting participation object.

The method 300 may include sending 316 notifications to the invitees based on the real-time participation statuses. The calendar system may send 316 notifications to the invitees. The invitees may receive the notifications on their devices. The calendar system may include triggers that determine if and when the calendar system sends notifications to the invitees. The triggers may include condition and notification pairs. The triggers may monitor one or more signals, including the real-time participation statuses, and determine whether the one or more signals meet a condition. The triggers may be designed such that if the one or more signals meet the condition, the calendar system sends the associated notification. In the alternative or in addition, the triggers may be designed such that if the one or more signals fail to meet the condition, the calendar system may send the associated notification.

The method 300 may include generating 318 a meeting summary of the meeting, the meeting summary stored in the meeting participation object. The meeting summary may be the meeting summary 112 or the meeting summary 212. Generating 318 the meeting summary may include generating an attendance record for the meeting. Generating 318 the meeting summary may involve use of telemetry data created when the intended participation statuses and the real-time participation statuses in the meeting participation object were updated, changed, or modified.

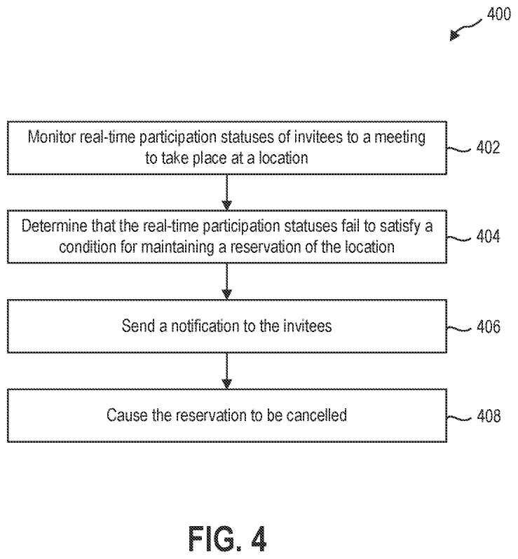

FIG. 4 illustrates an example method 400 for managing a conference room.

The method 400 may include monitoring 402 real-time participation statuses of invitees to a meeting, the meeting to take place at a location. The real-time participation statuses may be the real-time participation statuses 110 or the real-time participation statuses 210. The real-time participation statuses may be included in a participation object. The real-time participation statuses may be updated based on check-ins received from the invitees, from persons other than the invitees, from an application, or from a sensor. The real-time participation statuses may indicate whether the invitees are currently participating in the meeting and how the invitees are currently participating in the meeting. The calendar system may monitor the real-time participation statuses.

The method 400 may include determining 404 that the real-time participation statuses fail to satisfy a condition for maintaining a reservation of the location. In the alternative, the method 400 may include determining that the real-time participation statuses satisfy a condition for releasing the reservation of the location. The condition may be based on a policy established by an enterprise. The enterprise may control use of the location. The condition may require that within a predefined number of minutes after a start of the meeting, a minimum number of the real-time participation statuses must indicate that the invitees are currently present in-person at the meeting. The calendar system may determine that the real-time participation statuses fail to satisfy the condition for maintaining the reservation of the location or satisfy the condition for releasing the reservation of the location.

The method 400 may include sending 406 a notification to the invitees. The calendar system may send the notification to the invitees. The calendar system may send the notification to one or more devices associated with the invitees. The notification may warn the invitees that the reservation of the location may be released soon. The notification may indicate that the reservation of the location has been released. The notification may indicate a new location for the meeting.

The method 400 may include causing 408 the reservation to be cancelled. The calendar system may cause the reservation to be cancelled by communicating with a reservation system. Cancelling the reservation may allow others to access the reservation system and reserve the location.

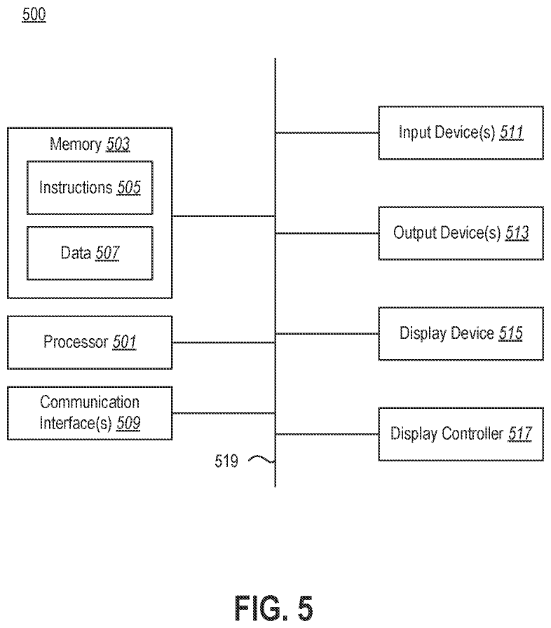

FIG. 5 illustrates certain components that may be included within a computer system 500. One or more computer systems 500 may be used to implement the various devices, components, and systems described herein. The one or more computer systems 500 may be part of a cloud platform, and the cloud platform may provide the one or more systems and methods described herein as a cloud service.

The computer system 500 includes a processor 501. The processor 501 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

In an example, the term “determining” (and grammatical variants thereof) encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for tracking participation in a meeting, comprising:
receiving a first check-in for a first invitee regarding a first presence of the first invitee at the meeting; and
updating a first real-time status for the first invitee based on the first check-in, wherein the first invitee is among a plurality of invitees, and wherein each of the plurality of invitees has an associated real-time status that indicates a current status of each of the plurality of invitees with respect to participating in the meeting;
sending, before a start time of the meeting, a meeting invitation to the plurality of invitees, wherein each of the plurality of invitees has an associated intended participation status, the intended participation status for each of the plurality of invitees indicates whether each invitee intends to attend the meeting and, if applicable, how each invitee intends to attend the meeting, and the intended participation status for each invitee is separate from the real-time status for each invitee;
receiving a first response to the meeting invitation for the first invitee; and updating a first intended participation status for the first invitee based on the first response; and
updating, after an end time of the meeting, a meeting summary, wherein the meeting summary indicates, based on the real-time status for each of the plurality of invitees, which of the plurality of invitees attended the meeting and, where applicable, how the plurality of invitees attended the meeting.

2. The method of any preceding claim, further comprising:
generating, upon updating the first real-time status, telemetry data, the telemetry data indicating when the first check-in was received and from whom the first check-in was received.

3. The method of any preceding claim, wherein the first check-in is received from the first invitee.

4. The method of claim 1 or claim 2, wherein the first check-in is received from another invitee other than the first invitee.

5. The method of any preceding claim, wherein the first check-in is received from a sensor.

6. The method of any preceding claim, further comprising: sending a notification to one or more of the plurality of invitees based on the first real-time status.

7. The method of any preceding claim, wherein the first real-time status indicates that the first invitee is currently present at a location of the meeting.

8. The method of any preceding claim, wherein the first real-time status indicates that the first invitee is currently in transit to attend the meeting in-person.

9. The method of any preceding claim, wherein the first real-time status indicates that the first invitee is not participating in the meeting.

10. The method of any preceding claim, wherein the first check-in is received from an application.

11. The method of claim 10, wherein the first real-time status indicates that the first invitee is currently attending the meeting virtually.

12. A method for managing reservations, comprising:
maintaining a real-time status with respect to a presence at a meeting for each invitee of the meeting, wherein the meeting has a plurality of invitees and a location and wherein the location is reserved for the meeting;
updating the real-time status of a first invitee of the plurality of invitees based on a check-in associated with the first invitee; and
releasing the location for use other than for the meeting based on the real-time status for each invitee of the meeting and a policy governing use of the location.

13. The method of claim 12, wherein the policy requires that the location be released if fewer than a minimum number of persons are present in-person at the meeting within an amount of time after a start time of the meeting.

14. The method of claim 13, wherein the amount of time after the start time of the meeting is zero.

15. The method of any one of claims 12 to 14, further comprising: assigning the meeting to a new location based on the real-time status for each invitee of the meeting.

16. The method of claim 15, further comprising: sending a notification to the plurality of invitees regarding the releasing and the assigning.

17. A system for tracking participation in a meeting, comprising:
one or more processors;
memory in electronic communication with the one or more processors; and
instructions stored in the memory, the instructions being executable by the one or more processors to:
send, before a start time of the meeting, a meeting invitation to a first invitee of the meeting,
receive a first response to the meeting invitation for the first invitee, wherein the first response indicates whether the first invitee intends to participate in the meeting and, if applicable, how the first invitee intends to participate in the meeting;
update a first intended participation status for the first invitee based on the first response;
receive a first check-in for the first invitee with respect to a presence at the meeting of the first invitee, wherein the first check-in indicates whether the first invitee is currently participating in the meeting and, if applicable, how the first invitee is currently participating in the meeting; and
update a first real-time status for the first invitee based on the first check-in.

18. The system of claim 17, wherein the first intended participation status and the first real-time status are included in a participation object and wherein the first intended participation status indicates that the first invitee intends to attend the meeting in-person and the first check-in indicates that the first invitee is participating in the meeting virtually.
